(19) United States
(12) Patent Application Publication
(10) Pub. No.: US 2008/0243566 A1
(43) Pub. Date: Oct. 2, 2008

(54) System, Method And Apparatus For Identifying And Correcting Data Integrity Problems Associated With Remotely Located Equipment

(76) Inventor: Bryan W. Godwin, Round Rock, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/691,789

(22) Filed: Mar. 27, 2007

(51) Int. Cl. G06F 9/44; G06Q 90/00

(52) U.S. Cl. 705/7

(57) ABSTRACT

A method, system and apparatus for identifying and correcting data integrity problems associated with remotely located equipment, e.g. vending machines, are provided. A handheld device collects a first set of data and a second set of data associated with the remotely located equipment. The handheld device compares the first set of data with the second set of data, and based at least on the comparison, identifies one or more data integrity problems associated with the remotely located equipment.

### RELATED APPLICATION

This application is related to copending U.S. patent application Ser. No. 11/608,987 entitled System, Method and Apparatus for Vending Machine Wireless Audit and Cashless Transaction Support” filed Dec. 11, 2006, which is a divisional application of U.S. patent application Ser. No. 10/722,954 entitled System, Method and Apparatus for Vending Machine Wireless Audit and Cashless Transaction Support” filed Nov. 24, 2003, now U.S. Pat. No. 7,167,892, which claims the benefit of U.S. provisional application No. 60/429,756 entitled “System and Method for Wireless Audit and Cashless Transaction Transport” filed Nov. 27, 2002 by Erin M. Defosse and claims the benefit of U.S. provisional application No. 60/480,626 entitled “System and Method for Auditing a Vending Machine” filed Jun. 23, 2003 by Erin M. Defosse and is a continuation-in-part of U.S. patent application Ser. No. 09/971,170 filed on Oct. 4, 2001 by Erin M. Defosse and entitled “Remote Data Acquisition, Transmission and Analysis System Including Handheld Wireless Equipment,” (Attorney Docket No. 064814.0184) which is a continuation of U.S. patent application Ser. No. 09/267,254 filed on Mar. 12, 1999 by Erin M. Defosse and entitled “Wide Area Network Operation's Center that Sends and Receives Data from Vending Machines,” (Attorney Docket No. 064814.0107) now U.S. Pat. No. 6,457,038 that claims priority to U.S. Provisional Patent Application Ser. No. 60/078,645, filed Mar. 19, 1998, and entitled “Remote Data Acquisition and Transmission System for the Monitoring and Control of Vending Machines,” and U.S. Provisional Patent Application Ser. No. 60/099,434, filed Sep. 8, 1998, and entitled “Remote Data Acquisition and Transmission System.”

This application is also related to copending patent application entitled “Apparatus And Method For Controlling And Monitoring Access To A Storage Container”, application Ser. No. 11/425,579, filed Jun. 21, 2006, claiming priority to U.S. Provisional Patent Application Ser. No. 60/772,744 filed Feb. 13, 2006, copending patent application entitled “Apparatus And Method For Controlling Access To Remotely Located Equipment”, application Ser. No. 11/277,272, filed Mar. 23, 2006, claiming priority to U.S. Provisional Patent Application Ser. No. 60/729,106 Filed Oct. 22, 2005, copending patent application entitled “Apparatus And Method For Attaching An Electronic Module To A Lock Assembly” application Ser. No. 11/674,393, filed Feb. 13, 2007, claiming priority to U.S. Provisional Patent Application Ser. No. 60/772,700 filed Feb. 13, 2006.

This application is also related to copending patent application entitled “Apparatus and Method to Provide Multiple Wireless Communication Paths to and From Remotely Located Equipment”, application Ser. No. 11/539,331, which is a continuation-in-part of U.S. patent application Ser. No. 11/279,174 entitled “Method and System for Interfacing a Machine Controller and a Wireless Network” filed Apr. 10, 2006, (attorney docket no. 064814.0230), which is a continuation application of U.S. patent application Ser. No. 09/895,647 entitled “Method and System for Interfacing a Machine Controller and Wireless Network” filed Jun. 29, 2001, now U.S. Pat. No. 7,164,884.

This application is also related to copending patent application entitled “System and Method for Monitoring and Control of Beverage Dispensing Equipment”, application Ser. No. 11/374,339, filed Mar. 13, 2006, which is a continuation of U.S. patent application Ser. No. 09/923,046 filed Aug. 6, 2001 and entitled “System and Method for Monitoring and Control of Beverage Dispensing Equipment”, which claims priority to U.S. Provisional Patent Application Ser. No. 60/224,097 filed Aug. 9, 2000 and entitled “System and Method for Monitoring and Control of Beverage Dispensing Equipment”; and is a continuation-in-part of U.S. patent application Ser. No. 09/267,254 filed Mar. 12, 1999 entitled “Remote Data Acquisition and Transmission System” which claims priority to U.S. Provisional Patent Application Ser. No. 60/078,645, filed Mar. 19, 1998, and entitled “Remote Data Acquisition and Transmission System for the Monitoring and Control of Vending Machines” and U.S. Provisional Patent Application Ser. No. 60/099,434, filed Sep. 8, 1998, and entitled “Remote Data Acquisition and Transmission System.”

This application is also related to copending patent application entitled, “Remote Data Acquisition, Transmission and Analysis System Including Handheld Wireless Equipment”, application Ser. No. 11/229,607, filed Dec. 12, 2005, which: (a) is a divisional of U.S. patent application Ser. No. 09/971,170 filed Oct. 4, 2001 entitled “Remote Data Acquisition, Transmission and Analysis System Including Handheld Wireless Equipment”, which is a continuation-in-part of U.S. patent application Ser. No. 09/267,254 filed Mar. 12, 1999 entitled “Remote Data Acquisition and Transmission System and Method”, now issued as U.S. Pat. No. 6,457,038, which claims priority to U.S. Provisional Patent Application Ser. No. 60/078,645, filed Mar. 19, 1998, and entitled “Remote Data Acquisition and Transmission System for the Monitoring and Control of Vending Machines” and to U.S. Provisional Patent Application Ser. No. 60/099,434, filed Sep. 8, 1998, and entitled “Remote Data Acquisition and Transmission System”; and (b) claims priority to U.S. Provisional Patent Application Ser. No. 60/238,313, filed Oct. 5, 2000, and entitled “Remote Data Acquisition, Transmission and Analysis System Including Handheld Wireless Equipment.”

### TECHNICAL FIELD

Systems, apparatuses and methods are provided for identifying and correcting data integrity problems associated with remotely located equipment. More particularly, systems, apparatuses and methods are provided for identifying and correcting data integrity problems associated with remotely located equipment without requiring multiple service visits to the remotely located equipment.

### BACKGROUND OF THE INVENTION

Modern, electronic vending machines often contain microprocessor based control systems, sometimes referred to as “vending machine controllers.” Such systems may be used to control, monitor and record detailed information about the state of an associated vending machine including, but not limited to, sales, cash received and paid out, errors, events, temperatures, inventory change, lock and unlock. A vending machine controller (VMC) may also control, monitor and record information from peripheral devices associated with functions such as coin acceptance, change giving, displays, credit cards and wireless transactions. The European Vending Association's Data Transfer Standard (“EVA-DTS”) and the National Automatic Merchandising Association's (NAMA) Multi-Drop Bus/Internal Communications Protocol (MDB/ICP or MDB) are widely used formats for collecting, recording, transmitting and auditing data associated with vending machines.

Advances in electronics are now enabling the use of computer controls and data acquisition systems within each vending machine. Some of the latest vending machines make it possible for vending operators to download data and information associated with sales, inventory, and equipment status on-site onto portable computers or transmit vending machine data and information to a central location such as a network operations center. Many vending machines include vending machine controllers based on the International Multi-drop Bus Interface Standards developed by the National Automatic Merchandising Association (NAMA).

Advances in electronics have also enabled the use of controls and data acquisition systems in other types of remotely located equipment, e.g. service vehicles, snack machines, beverage machines, automatic teller machines (ATMs), postage stamp dispensers, arcade machines, slot machines, laundry machines and car wash equipment, in addition to vending machines. However, there are many known disadvantages to such control and data acquisition systems in remotely located equipment, particularly in the area of identifying and detecting data integrity problems associated with remotely located equipment. For example, known systems may require that, in order to effectively correct a data integrity problem, a service technician must often be dispatched multiple times to an item of remotely located equipment. In many instances, a service technician must be dispatched a first time to the remotely located equipment to collect data associated with an item of remotely located equipment, the data returned to a host device or central location where the collected data is compared with data associated with an expected state of the remotely located equipment to identify the existence of a data integrity problem, and then a service technician must be dispatched a second time to the remotely located equipment to correct any identified data integrity problem.

To illustrate some of the disadvantages associated with known methods and systems, FIG. 1 depicts an example method 100 for identifying and correcting a data integrity problem in accordance with the prior art. At step 102, a service technician equipped with a handheld computing device is dispatched to a vending machine or other item of remotely located equipment. At step 104, once the service technician has reached the vending machine, the handheld computing device collects data associated with an actual state of the vending machine. Such data may include the type or model number of the vending machine, planogram data related to the vending machine, or inventory data related to the vending machine.

As used herein, the term “service technician” may refer to any person that may maintain, repair, stock, deliver products to, collect money from, or otherwise service an item of remotely located equipment.

At step 106, after data associated with the actual state of the vending machine is collected, the service technician returns the handheld computing device to the location of a host device. The host device may a computing device comprising data associated with an expected state of the vending machine, e.g. data collected during a previous service visit to the vending machine. At step 108, data associated with the actual state of the vending machine is transmitted to the host device. At step 110, the host device compares data associated with the actual state of the vending machine with data associated with the expected state of the vending machine. Based on the comparison, the host may identify a data integrity problem associated with the vending machine at step 112. A data integrity problem may occur if the actual data varies from the expected data. For example, if based on sales data collected from the vending machine, the actual data reports that ten cans of cola remain in the vending machine, but the expected data reports that, based on such sales data, that it is expected that twelve cans of cola remain in the vending machine, then a data integrity problems has occurred.

If a data integrity problem is identified, a service technician is dispatched to the vending machine at step 114 to correct the data integrity problem. Thus, it can be seen from method 100 that known systems and methods for identifying and correcting data integrity problems in remotely located equipment such as vending machines may require two or more service visits to such remotely located equipment, potentially causing an owner of the remotely located equipment time and expense that would not otherwise be incurred if fewer service visits were required.

### SUMMARY OF THE DISCLOSURE

Therefore, a need has arisen for improved systems, apparatuses and methods for identifying and correcting data integrity problems associated with remotely located equipment. In accordance with teachings of the present disclosure, systems, apparatuses and methods may be presented for identifying and correcting data integrity problems associated with remotely located equipment.

In one embodiment of the disclosure, a method for identifying and correcting data integrity problems associated with a vending machine is provided. A handheld device collects a first set of data and a second set of data associated with the vending machine. The handheld device compares the first set of data with the second set of data, and based at least on the comparison, identifies one or more data integrity problems associated with the vending machine.

In another embodiment of the disclosure a method for identifying and correcting data integrity problems associated with remotely located equipment is provided. A handheld device collects a first set of data and a second set of data associated with the remotely located equipment. The handheld device compares the first set of data with the second set of data, and based at least on the comparison, identifies one or more data integrity problems associated with the remotely located equipment.

In yet another embodiment of the disclosure, a system for identifying and correcting data integrity problems associated with a vending machine comprises a host and a handheld computing device. The device host may be operable to communicate a first set of data. The handheld computing device may be operable to collect the first set of data, collect a second set of data associated with a vending machine, compare the first set of data with the second set of data, and based at least on the comparison, identify one or more data integrity problems associated with the vending machine.

In yet another embodiment of the disclosure, a system for identifying and correcting data integrity problems associated with remotely located equipment comprises a host and a handheld computing device. The device host may be operable to communicate a first set of data. The handheld computing device may be operable to collect the first set of data, collect a second set of data associated with the remotely located equipment, compare the first set of data with the second set of data, and based at least on the comparison, identify one or more data integrity problems associated with the remotely located equipment.

In yet another embodiment of the disclosure, an apparatus for identifying and correcting data integrity problems associated with a vending machine comprises at least one memory, at least one data input interface, and at least one processor. The at least one data input interface may be operably coupled to the memory, and may be operable to collect a first set of data associated with the vending machine. The at least one processor may be operably coupled to the memory and the communication port, and may be operable to compare the first set of data with a second set of data, and based at least on the comparison, identify one or more data integrity problems associated with the vending machine.

In yet another embodiment of the disclosure, an apparatus for identifying and correcting data integrity problems associated with remotely located equipment comprises at least one memory, at least one data input interface, and at least one processor. The at least one data input interface may be operably coupled to the memory, and may be operable to collect a first set of data associated with the remotely located equipment. The at least one processor may be operably coupled to the memory and the communication port, and may be operable to compare the first set of data with a second set of data, and based at least on the comparison, identify one or more data integrity problems associated with the remotely located equipment.

In yet another embodiment of the disclosure, a computer program for identifying and correcting data integrity problems associated with a vending machine is provided. The computer program may be embodied in tangible computer readable media and when executed operable to collect a first set of data, collect a second set of data associated with the vending machine, compare the first set of data with a second set of data and based at least on the comparison, identify one or more data integrity problems associated with the vending machine.

In yet another embodiment of the disclosure, a computer program for identifying and correcting data integrity problems associated with remotely located equipment is provided. The computer program may be embodied in tangible computer readable media and when executed operable to collect a first set of data, collect a second set of data associated with the remotely located equipment, compare the first set of data with a second set of data and based at least on the comparison, identify one or more data integrity problems associated with the remotely located equipment.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 depicts an example method for identifying and correcting a data integrity problem in accordance with the prior art;

FIG. 2 illustrates a block diagram showing one example of a system for facilitating identification and correction of data integrity problems associated with vending machines in accordance with the present disclosure; and

FIG. 3 depicts an example method for identifying and correcting a data integrity problem in accordance with the present disclosure.

### DETAILED DESCRIPTION OF THE DISCLOSURE

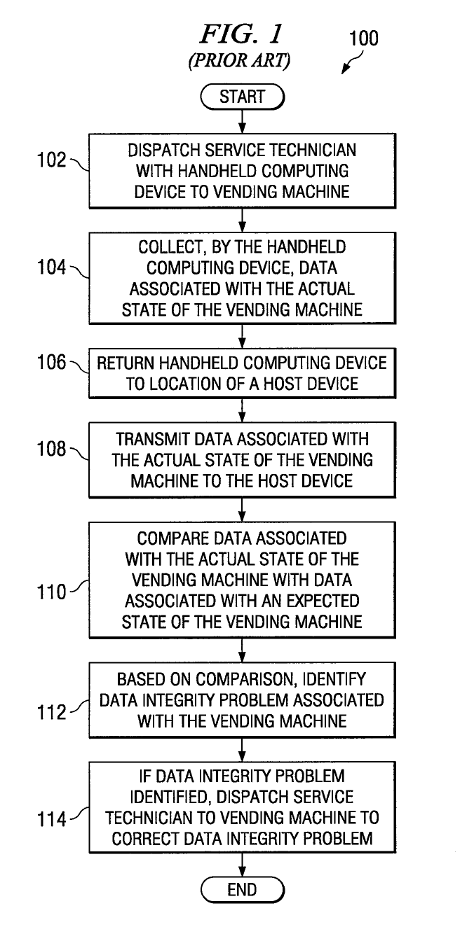

Preferred embodiments of the disclosure and various advantages are best understood by reference to FIGS. 1-3 wherein like numbers refer to same and like parts.

Various aspects of the present disclosure may be described with respect to handheld computing devices. However, various embodiments of the present disclosure may not require the use of a handheld computing device but may instead utilize a personal computer, general purpose computer, or other suitable device.

The term “remotely located equipment” may be used in this application to refer to any automatic sales machine that allows payment to be exchanged for goods or services including, but not limited to, all types of service vehicles, vending machines, snack machines, beverage machines, automatic teller machines (ATMs), postage stamp dispensers, arcade machines, slot machines, laundry machines, car wash equipment, copiers, ice manufacturing and dispensing equipment, computer work stations, photographic booths, service vehicles, and any other type of equipment or machine that requires routine maintenance, monitoring and servicing. According to the teachings contained herein, remote point of sale equipment and remote dispensing equipment are not necessarily indicative of similar devices and, further, further, the present invention is not limited to use with only vending machines.

The term “wire-line transmissions” may be used to refer to all types of electromagnetic communications over wires, cables, or other types of conduits. Examples of such conduits include, but are not limited to, metal wires and cables made of copper or aluminum, fiber-optic lines, and cables constructed of other metals or composite materials satisfactory for carrying electromagnetic signals. Wire-line transmissions may be conducted in accordance with teachings of the present disclosure over electrical power lines, electrical power distribution systems, building electrical wiring, conventional telephone lines, ethernet cabling (10baseT, 100baseT, etc.), coaxial cables, T-1 lines, T-3 lines, ISDN lines, ADSL, etc.

The term “wireless transmissions” may be used to refer to all types of electromagnetic communications which do not require a wire, cable, or other types of conduits. Examples of wireless transmissions which may be used include, but are not limited to, personal area networks (PAN), local area networks (LAN), wide area networks (WAN), narrowband personal communications services (PCS), broadband PCS, circuit switched cellular, cellular digital packet data (CDPD), radio frequencies, such as the 800 MHz, 900 MHz, 1.9 GHz and 2.4 GHz bands, infra-red and laser.

Examples of wireless transmissions for use in local area networks (LAN) include, but are not limited to, radio frequencies, especially the 900 MHZ and 2.4 GHz bands, such as IEEE 802.11 and BLUETOOTH, as well as infrared, and laser. Examples of wireless transmissions for use in wide area networks (WAN) include, but are not limited to, narrowband personal communications services (nPCS), personal communication services (PCS such as CDMA, TMDA, GSM) circuit switched cellular, and cellular digital packet data (CDPD), etc.

The term “host device” may refer to, without limitation, any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, a host device may be a personal computer, a personal digital assistant, a consumer electronic device, a server, a network storage device, or any other suitable device and may vary in size, shape, performance, functionality, and price. A host device may include memory, one or more processing resources such as a central processing unit (CPU), or hardware or software control logic. A host device may also include one or more storage devices, one or more communications ports for communicating with external devices as well as various input and output (I/O) devices, such as a keyboard, a mouse, and a video display. A host device may also include one or more buses operable to transmit communication between the various hardware components.

The term “handheld computing device” may refer to, without limitation, any mobile or handheld instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, a handheld computing device may be a personal digital assistant, a cellular phone, a consumer electronic device, or any other suitable device and may vary in size, shape, performance, functionality, and price. A handheld computing device may include memory, one or more processing resources such as a central processing unit (CPU), or hardware or software control logic. A handheld computing device may also include one or more storage devices, one or more communications ports for communicating with external devices as well as various input and output (I/O) devices, such as a keyboard, a mouse, and a video display.

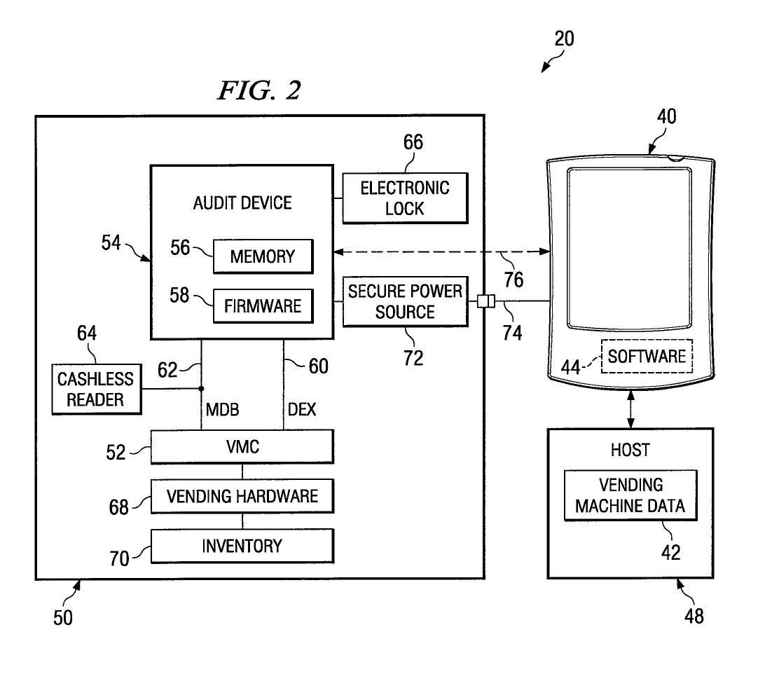

FIG. 2 illustrates a block diagram showing one example of a system 20 for facilitating identification and correction of data integrity problems associated with vending machines. Although system 20 depicts a system for facilitating identification and correction of data integrity problems associated with vending machines, the teachings set forth in this disclosure may also apply to facilitating identification and correction of data integrity problems associated with other types of remotely located equipment.

System 20 may comprise vending machine 50, and may be operable to monitor and record inventory levels, product sales and operating status of associated mechanical and/or electrical components. System 20 may include one or more handheld devices 40 and one or more vending machines 50. For some applications handheld device 40 may be a handheld computer or personal data assistant (PDA).

Various communication networks and communication techniques may be satisfactorily used to communicate data and other information between the various components associated with system 20. Examples of such communication networks may include, but are not limited to, wide area networks, public communication networks and client networks or private networks. Each of these networks may include a wide variety of wire-line transmission techniques and/or wireless transmission techniques. For example, public communication networks may include, but are not limited to, a public switched telephone network (PSTN), the Internet, IP telephony or voice over IP (VoIP), cable networks and a wide variety of wireless networks which are being developed in many communities for access by the general public. The boundary lines or dividing lines between “conventional” wide area networks, public communication networks and client networks or private networks are subject to substantial variations, overlaps and rapid change as communication technology and techniques are developed.

Vending machine 50 may include vending machine controller (VMC) 52 operable to control and monitor various electronic components and mechanical components associated with vending machine 50. Vending machine 50 may also include audit device 54 having memory 56 and firmware 58 or similar components such as a general purpose computer with wireless and/or wire-line communication capabilities. For some applications, audit device 54 may be operable to obtain DEX data via DEX interface or communication link 60 from vending machine controller 52. Audit device 54 may automatically collect DEX data and equipment operating status according to predefined collection criteria. Audit device 54 may store such audit data with associated timestamps to record occurrence times for individual events and conditions within the remotely located equipment. Audit device 54 may also be operable to obtain multi-drop bus (MDB) data via MDB interface or communication link 62 from vending machine controller 52. Audit device 54 may also obtain MDB data from various peripherals including, but not limited to, cashless reader 64. Audit device 54 may archive or store the DEX data and MDB data in memory 56.

Audit device 54 may also receive authentication information from a laptop computer (not expressly shown), handheld device 40 or any other electronic component operable to communicate with audit device 54. In response to the authentication information, audit device 54 may test the authentication information for validity. After receiving valid authentication data, audit device 54 may synchronize a clock in audit device 54 with a clock in handheld device 40 and transfer at least a portion of the audit data to handheld device 40. The audit data may be transmitted by one or more communication techniques from handheld device 40 to vending machine 50 for recording and analysis of various functions at vending machine 50. Such functions may include, but are not limited to, unlocking a door to provide access for servicing the remotely located equipment and locking the door upon completion of servicing the remotely located equipment.

Audit device 54 may be operable to perform some or all of the functions of an application host such as described in U.S. Pat. No. 6,457,038, entitled “Wide Area Network Operations Center that Sends and Receives Data from Vending Machines” and U.S. Pat. No. 6,925,335 entitled “Real-Time Alert Mechanism for Monitoring and Controlling Field Assets Via Wireless and Internet Technologies.”

Audit device 54 may acquire data captured by vending machine controller 52, package and communicate such data across one or more external communication networks 24. Various communication interfaces (not expressly shown) such as wide area network (WAN) interfaces, local area networks (LAN) and personal area networks (PAN) may also be provided within audit device 54 and/or other components associated with vending machine 50.

For some applications audit device 54 and VMC 52 may be separate components such as shown in FIG. 2. For other applications audit device 54 and VMC 52 may be formed as integral components (not expressly shown). At some locations with multiple vending machines, one or more vending machines may include an audit device operable to communicate with vending machine controllers and/or audit devices associated with other vending machines at the same location.

Vending machine 50 may include one or more hardware devices or peripheral devices. Cashless reader 64 may be representative of such hardware devices and peripherals. Cashless reader or cashless media device 64 may be operable to accept noncash payment tokens such as credit cards, RFID (Radio Frequency Identification Devices) or other media representative of noncash payment.

Vending machine 50 may include electronic lock 66 which may be operably coupled with audit device 54 via an electronic module (not expressly shown in FIG. 1). Audit device 54 may be operable to send commands or actuation codes to the electronic module to engage or disengage electronic lock 66.

To provide operational status feedback to a service personnel and/or customers, audit device 54 may include a user interface system. In one embodiment, the user interface system may include one or more light emitting diodes (LEDs) operational to communicate status feedback as to one or more aspects of audit device 54 and/or vending machine 50. The user interface subsystem may also include a reset button or an MDB/on-off switch. A secondary user interface subsystem may also be available to service personnel through use of software 44 and handheld device 40.

Vending machine 50 may also include vending hardware 68 and vending inventory 70. Examples of vending machine hardware 68 may include, but are not limited to, inventory dispensing apparatus, one or more coin acceptance and verification mechanisms, one or more bill acceptance and validation mechanisms or any other hardware device associated with vending machines.

Vending machine 50 may also include secure power source 72 (e.g., a battery) operably coupled to audit device 54. For some applications secure power source 72 may also provide power to an electronic module associated with electronic lock 66 in the event of power failure to vending machine 50 or as may be appropriate at other selected time periods. Secure power source 72 may include link or interface 74 externally available on vending machine 50. Secure power source 72 may include one or more suppression and power conditioning devices operable to help guard against electronic attack or unauthorized access to vending machine 50.

As shown in FIG. 2, secure power source 72 may be connected with handheld device 40 via link or interface 74 such that audit device 54 may be powered by handheld device 40 or audit device 54 may receive power from secure power source 72 as needed, for example, in event of power failure to vending machine 50 or at other selected time periods.

Communication link or interface 74 such as shown in FIG. 2 may allow communication of electrical signals between handheld device 40 and audit device 54. Also, link 74 may provide electrical power from secure power source 72 to handheld device 40. Alternatively, in the event of an emergency at vending machine 50, handheld device 40 may provide electrical power through link 74 to operate audit device 54. Such wire-line connections provide multiple redundancy with respect to the data communication and supplying power required to operate handheld device 40 and/or audit device 54.

Handheld device 40 may be operable to communicate with audit device 54 using software 44 and wireless communications 76. Handheld device 40 and audit device 54 may be equipped with one or more wireless transceivers (not expressly shown). Examples of wireless communications that may be satisfactorily used with handheld device 40 and audit device 54 include, but are not limited to, BLUETOOTH, IEEE802.11a, IEEE802.11b and IEEE802.11g. To enable vending machine 50 to communicate wirelessly with handheld device 40, audit device 54 and handheld device 40 may include respective BLUETOOTH transceivers (cards) and/or 802.11 transceivers (cards). In part for purposes of failover or redundancy, vending machine 50 and handheld device 40 may also include wired or wire-line communication connection capabilities.

In addition to DEX data and MDB data, audit device 54 may record and store other transactions or activities associated with vending machine 50. For example audit device 54 may record information concerning transactions such as date and time of each engagement and disengagement of electronic lock 66 and identification of handheld device 40 which initiated engagement and/or disengagement of electronic lock 66. Audit device 54 may also record operational matters such as compressor failure, vend failures, inventory depletion and correct change events as well as other matters associated with modern electronic vending machine activities and transactions.

When handheld device 40 and audit device 54 communicate with each other over wireless communication link 76, DEX data and MDB data stored in memory 56 may be transferred on demand to handheld device 40. In addition, handheld device 40 may include one or more software applications 44 operable to command audit device 54 to allow access to vending machine 50. For example, handheld device 40 may be used to disengage electronic lock 66 to provide access to interior portions of vending machine 50.

Although FIG. 2 depicts handheld device 40 communicating with audit device 54 of vending machine 50 in order facilitate transmission of data from vending machine 50 to handheld device 40, it is understood that transmission of data between vending machine 50 and handheld device 50 may occur in any suitable manner. For example, in some embodiments, vending machine 50 may not include audit device 54. In the same or alternative embodiments, handheld device 40 may communicate with other components of vending machine 50. For example, audit device 40 may communicate directly with MDB port 62 and/or DEX port 60 of VMC 52 in order to facilitate transmission of data between vending machine 50 and handheld device 40.

In addition, although FIG. 2 depicts that handheld device 40 collects data from vending machine 50 via a wire-line or wireless coupling, it is understood that handheld device 40 may collect data from vending machine via any suitable manner. For example, in some embodiments, vending machine 50 may not include wire-line link 74 and/or wireless communication link 76. In the same or alternative embodiments, handheld device 40 may be operable to collect data associated with vending machine 50 via manual entry of data, e.g. manual entry of data into handheld device 40 by a service technician.

Handheld computing device 40 may also be employed as a proxy or go-between for vending machine 50 and host device 48. In one embodiment, handheld computing device may be used to communicate data from vending machine 50 to host device 48. Host device 48 may include vending machine data 42, for use in facilitating identification and correction of data integrity problems associated with data collected by handheld device 40 from vending machine 50. Handheld computing device 40 may communicate with host device 48 in any suitable manner, including, but not limited to, wireless and/or wire-line communication mediums.

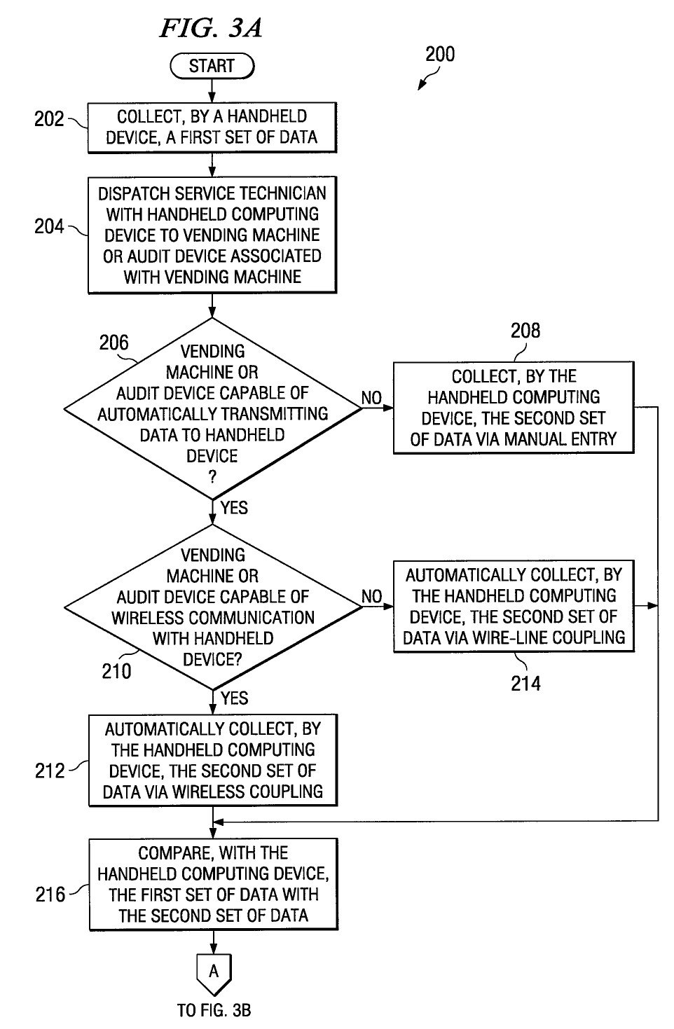

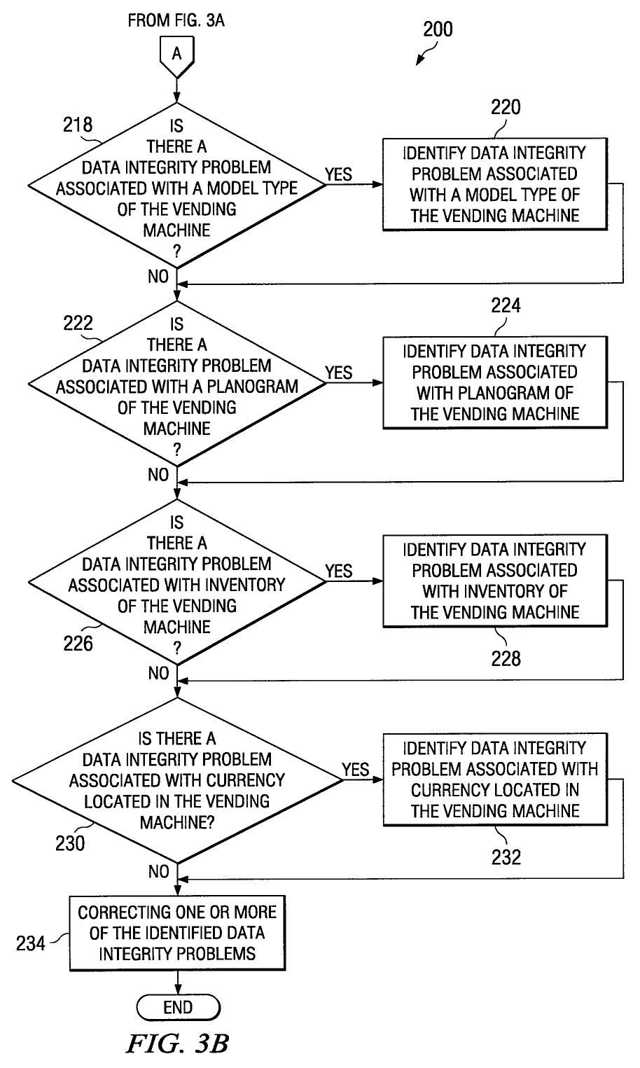

Referring now to FIG. 3, an example method 200 for identifying and correcting a data integrity problem is depicted. Method 200 is depicted in FIG. 3 as starting at step 202. At step 202, handheld device 40 may collect a first set of data. In certain embodiments, the first set of data may comprise data regarding an expected state of a vending machine, e.g. vending machine 50, or item of remotely located equipment. For example, in certain embodiments, the first set of data may comprise the expected model or type of a particular vending machine 50, expected planogram data (as defined below) of a particular vending machine 50, expected inventory of a vending machine 50, and/or an expected amount of currency located in a vending machine 50. In the same or alternative embodiments, the first set of data may comprise data collected during a previous service visit to a particular vending machine 50. In the same or alternative embodiments, the first set of data may be collected by transmission of vending machine data 42 from host 48 to handheld device 40.

At step 204, a service technician may be dispatched along with handheld device 40 to vending machine 50 or an audit device 54 associated with vending machine 50. At step 206 a determination may be made as to whether vending machine 50 or audit device 54 is capable of automatically transmitting data to handheld device 40. Such determination may be made by any suitable manner, including, without limitation, a determination by a service technician as to whether vending machine 50 comprises a DEX port or other external port for communicating data with handheld device 40.

If, at step 206, it is determined that vending machine 50 is not capable of transmitting data to handheld device 40, method 200 may proceed to step 208. Otherwise, method 200 may proceed to step 210. At step 208, handheld device 40 may collect a second set of data via manual data entry, e.g., by manual data entry by a service technician, of data associated with vending machine 50. After completion of step 208, method 200 may proceed to step 216.

At step 210, a determination may be made as to whether or not vending machine 50 and/or audit device 54 is capable of wireless communication with handheld device 40. Such determination may be made by any suitable manner. For example, in some embodiments, handheld device 40, using software 44, may detect whether or not vending machine 50 and/or audit device is transmitting a wireless signal.

If, at step 210, it is determined that vending machine 50 and/or audit device 54 is capable of wireless communication with handheld device 40, method 200 may proceed to step 212. Otherwise, method 200 may proceed to step 214. At step 212, handheld device 40 may collect a second set of data from vending machine 50 via wireless coupling. Alternatively, at step 214, handheld device 40 may collect a second set of data from vending machine 50 via wire-line coupling. After completion of step 212 or step 214, method 200 may proceed to step 216.

The second set of data collected at step 208, 212 or 214 may be any data or information associated with the operation of vending machine 50 or other item or remotely located equipment. In some embodiments, the second set of data may comprise data associated with the a type or model number of vending machine 50. In the same or alternative embodiments, the second set of data may comprise data associated with a planogram of vending machine 50. In the same or alternative embodiments, the second set of data may comprise data associated with the inventory of vending machine 50. In the same or alternative embodiments, the second set of data may comprise data associated with currency located in vending machine 50.

As used in this disclosure, “planogram” or “planogram data” means a collection of data associated with the relationship among products placed in a vending machine, the product location(s) or columns(s) within the vending machine, the possible consumer selections of products for the vending machine, and the price of products dispensed from the vending machine. The table below sets forth an example planogram for vending machine 50:

| Column | Selection/Button | Product | Price |
|---|---|---|---|
| 1 | 1 | Cola | 75 cents |
| 2 | 1 | Cola | 75 cents |
| 3 | 2 | Diet Cola | 75 cents |
| 4 | 2 | Diet Cola | 75 cents |
| 5 | 3 | Water | 60 cents |

Thus, in the above example planogram, a consumer may purchase a cola priced at 75 cents by tendering the appropriate purchase price (e.g., by tendering currency or some form of cashless payment) and actuation of selection 1 (e.g., by depressing a button labeled with the product to be purchased). In accordance with the above planogram, a cola, if in stock in the vending machine, may be dispensed from either column 1 or column 2 of the vending machine.

Although method 200 may depict that the second set of data may only be collected via manual entry, wireless transmission, or wire-line transmission, it is understood that the second set of data may be collected by any combination of manual entry, wireless transmission, and wire-line transmission. For example, in a particular embodiment, a model type associated with a vending machine may be input manually by a service technician while data associated with a planogram of the vending machine, inventory, and currency located in the vending machine may be transmitted via wire-line and/or wireless transmission.

Referring again to FIG. 3, at step 216 of method 200, software 44 of handheld device 40 may compare the first set of data with the second set of data to determine whether or not a data integrity problem exists between the two sets of data. At step 218, software 44 may determine that a data integrity problem associated with a model or type of the vending machine exists. For example, the first set of data collected may indicate that a particular vending machine is expected to be of a certain model, while the second set of data may indicate that the vending machine is of a different model. If, at step 218, a data integrity problem associated with a model or type of the vending machine is determined to exist, the problem may be identified at step 220.

At step 222, software 44 may determine that a data integrity problem associated with a planogram of the vending machine exists. For example, the first set of data collected may indicate that a particular column of the vending machine is expected to contain cola, while the second set of data may indicate that the particular column of the vending machine actually contains diet cola. If, at step 222, a data integrity problem associated with a planogram of the vending machine is determined to exist, the problem may be identified at step 224.

At step 226, software 44 may determine that a data integrity problem associated with inventory of the vending machine exists. For example, the first set of data collected may indicate that the vending machine is expected to contain 20 cans of diet cola, while the second set of data may indicate that the vending machine actually contains 25 cans of diet cola. If, at step 226, a data integrity problem associated with inventory of vending machine is determined to exist, the problem may be identified at step 228.

At step 230, software 44 may determine that a data integrity problem associated with currency located in the vending machine. For example, the first set of data collected may indicate that the vending machine is expected to contain 300 quarters, while the second set of data may indicate that the vending machine actually contains 280 quarters. If, at step 230, a data integrity problem associated with inventory of vending machine is determined to exist, the problem may be identified at step 232.

In some embodiments, the determination and identification of data integrity problems depicted in steps 216 through 232 may occur substantially contemporaneously with the service technician's dispatch to vending machine 50, thus allowing data integrity problems to be identified (and thus corrected) while the service technician is at or near vending machine 50 or an audit device 54 associated therewith.

At step 234 the one or more identified data integrity problems may be corrected. In certain embodiments, one more identified data integrity problems may be corrected automatically. For example, if it is determined that a data integrity problem associated with inventory exists, software 44 may update the portion of the first set of data related to inventory to match the portion of the second set of data related to inventory. In the same or alternative embodiments, one or more identified integrity problems may be corrected manually. For example, if an identified data integrity problem is associated with a model type of the vending machine, the dispatched service technician may enter, via manual data entry, the correct model type into handheld device 40 and software 44 may then modify the first or second set of data appropriately. In the same or alternative embodiments, software 44 may display instructions via handheld device 40 to the service technician to correct the one or more data integrity problems. For example, if a data integrity problem associated with the amount of currency in the vending machine is determined to exist, software 44 may display instructions instructing the service technician to add or remove currency from the vending machine to correct the data integrity problem.

Although FIG. 3 depicts steps occurring in a particular order, it is understood that the steps set forth in method 200 may be performed in any suitable order or manner.

Although the present disclosure and its advantages have been described in detail, it should be understood that various changes, substitutions and alterations may be made thereto without departing from the spirit and scope of the disclosure as defined by the following claims.

What is claimed is:

1. A method for identifying and correcting data integrity problems associated with a vending machine comprising:
collecting, in a handheld computing device, a first set of data;
collecting, in the handheld computing device, a second set of data associated with the vending machine;
comparing, with the handheld computing device, the first set of data with the second set of data; and
based at least on the comparison, identifying one or more data integrity problems associated with the vending machine.

2. The method of claim 1, further comprising dispatching a service technician to the vending machine or an audit device associated with the vending machine, wherein:
(a) the collecting of the second set of data,
(b) the comparison of the first set of data with the second set of data, and
(c) the identifying of one or more data integrity problems
occur substantially contemporaneous with the service technician's dispatch to the vending machine or the audit device associated with the vending machine.

3. The method of claim 2, further comprising correcting one or more of the identified data integrity problems.

4. The method of claim 1, the first set of data comprising information associated with an expected state of the vending machine.

5. The method of claim 1, the second set of data comprising information associated with an actual state of the vending machine.

6. The method of claim 1, the data integrity problems comprising at least one of: (a) a data integrity problem associated with a model type of the vending machine, (b) a data integrity problem associated with a planogram of the vending machine, (c) a data integrity problem associated with inventory of the vending machine, and (d) a data integrity problem associated with currency located in the vending machine.

7. The method of claim 1, the collecting of the second set of data comprising automatic transmission of the second set of data from the vending machine or an audit device associated with the vending machine.

8. The method of claim 7, the automatic transmission of the second set of data comprising transmission of the second set of data via a wireless coupling.

9. The method of claim 7, the automatic transmission of the second set of data comprising transmission of the second set of data via a wire-line coupling.

10. The method of claim 1, the collecting of the second set of data comprising manual data entry of the second set of data into the handheld computing device.

11. The method of claim 1, the collecting of the second set of data comprising collecting the second set of data from an audit device associated with the vending machine.

12. The method of claim 1, the second set of data comprising data exchange (DEX) data associated with the vending machine.

13. The method of claim 1, the collecting of the first set of data comprising transmitting the first set of data from a host device to the handheld computing device.

14. A method for identifying and correcting data integrity problems associated with remotely located equipment comprising:
collecting, in a handheld computing device, a first set of data;
collecting, in the handheld computing device, a second set of data associated with the remotely located equipment;
comparing, with the handheld computing device, the first set of data with the second set of data; and
based at least on the comparison, identifying one or more data integrity problems associated with the remotely located equipment.

15. The method of claim 14, further comprising dispatching a service technician to the remotely located equipment, wherein:
(a) the collecting of the second set of data,
(b) the comparison of the first set of data with the second set of data, and
(c) the identifying of one or more data integrity problems
occur substantially contemporaneous with the service technician's dispatch to the remotely located equipment.

16. The method of claim 15, further comprising correcting one or more of the identified data integrity problems.

17. The method of claim 14, the first set of data comprising information associated with an expected state of the remotely located equipment.

18. The method of claim 14, the second set of data comprising information associated with an actual state of the remotely located equipment.

19. The method of claim 14, the collecting of the second set of data comprising automatic transmission of the second set of data from the remotely located equipment.

20. The method of claim 19, the automatic transmission of the second set of data comprising transmission of the second set of data via a wireless coupling.

21. The method of claim 19, the automatic transmission of the second set of data comprising transmission of the second set of data via a wire-line coupling.

22. The method of claim 14, the collecting of the second set of data comprising manual data entry of the second set of data into the handheld computing device.

23. The method of claim 14, the collecting of the first set of data comprising transmitting the first set of data from a host device to the handheld computing device.

24. A system for identifying and correcting data integrity problems associated with a vending machine comprising:
a host device operable to communicate a first set of data;
a handheld computing device operable to:
collect the first set of data;
collect a second set of data associated with a vending machine;
compare the first set of data with the second set of data; and
based at least on the comparison, identify one or more data integrity problems associated with the vending machine.

25. The system of claim 24, the handheld computing device further operable to:
(a) collect the second set of data,
(b) compare the first set of data with the second set of data, and
(c) identify the one or more data integrity problems
substantially contemporaneously with a service technician's dispatch to the vending machine or an audit device associated with the vending machine.

26. The system of claim 25, the handheld computing device further operable to provide instructions to a service technician to correct the one or more data integrity problems.

27. The system of claim 24, the first set of data comprising information associated with an expected state of the vending machine.

28. The system of claim 24, the second set of data comprising information associated with an actual state of the vending machine.

29. The system of claim 24, the data integrity problems comprising at least one of: (a) a data integrity problem associated with a model type of the vending machine, (b) a data integrity problem associated with a planogram of the vending machine, (c) a data integrity problem associated with inventory of the vending machine, and (d) a data integrity problem associated with currency located in the vending machine.

30. The system of claim 24, the handheld computing device further operable to collect the second set of data via automatic transmission of the second set of data from the vending machine or an audit device associated with the vending machine.

31. The system of claim 30, the handheld computing device further operable to collect the second set of data via transmission of the second set of data via a wireless coupling.

32. The system of claim 30, the handheld computing device further operable to collect the second set of data via transmission of the second set of data via a wire-line coupling.

33. The system of claim 24, the handheld computing device further operable to collect the second set of data via manual data entry of the second set of data into the handheld computing device.

34. The system of claim 24, the handheld computing device further operable to collect the second set of data from an audit device associated with the vending machine.

35. The system of claim 24, the second set of data comprising data exchange (DEX) data associated with the vending machine.

36. The system of claim 24, the handheld computing device further operable to collect the first set of data via automatic transmission of first set of data from the host device to the handheld computing device.

37. A system for identifying and correcting data integrity problems associated with remotely located equipment comprising:
a host device operable to communicate a first set of data;
a handheld computing device operable to:
collect a first set of data;
collect a second set of data associated with the remotely located equipment;
compare the first set of data with the second set of data; and
based at least on the comparison, identify one or more data integrity problems associated with the remotely located equipment.

38. The system of claim 37, the handheld computing device further operable to
(a) collect the second set of data,
(b) compare the first set of data with the second set of data, and
(c) identify the one or more data integrity problems
substantially contemporaneously with a service technician's dispatch to the remotely located equipment.

39. The system of claim 38, the handheld computing device further operable to provide instructions to a service technician to correct the one or more data integrity problems.

40. The system of claim 37, the first set of data comprising information associated with an expected state of the remotely located equipment.

41. The system of claim 37, the second set of data comprising information associated with an actual state of the remotely located equipment.

42. The system of claim 37, the handheld computing device further operable to collect the second set of data via automatic transmission of the second set of data from the remotely located equipment.

43. The system of claim 42, the handheld computing device further operable to collect the second set of data via transmission of the second set of data via a wireless coupling.

44. The system of claim 42, the handheld computing device further operable to collect the second set of data via transmission of the second set of data via a wire-line coupling.

45. The system of claim 37, the handheld computing device further operable to collect the second set of data via manual data entry of the second set of data into the handheld computing device.

46. The system of claim 37, the handheld computing device further operable to collect the first set of data via automatic transmission of first set of data from the host device to the handheld computing device.

47. An apparatus for identifying and correcting data integrity problems associated with a vending machine comprising:
at least one memory;
at least one data input interface operably coupled to the memory, the data input interface operable to collect a first set of data associated with the vending machine;
at least one processor operably coupled to the memory and the communication port, the processor operable to:
compare the first set of data with a second set of data; and
based at least on the comparison, identify one or more data integrity problems associated with the vending machine.

48. The apparatus of claim 47, the processor further operable to:
(a) collect the second set of data,
(b) compare the first set of data with the second set of data, and
(c) identify the one or more data integrity problems
substantially contemporaneously with a service technician's dispatch to the vending machine or an audit device associated with the vending machine.

49. The apparatus of claim 48, further comprising a user interface operable to provide instructions to a service technician to correct the one or more data integrity problems.

50. The apparatus of claim 47, the first set of data comprising information associated with an expected state of the vending machine.

51. The apparatus of claim 47, the second set of data comprising information associated with an actual state of the vending machine.

52. The apparatus of claim 47, the data integrity problems comprising at least one of: (a) a data integrity problem associated with a model type of the vending machine, (b) a data integrity problem associated with a planogram of the vending machine, (c) a data integrity problem associated with inventory of the vending machine, and (d) a data integrity problem associated with currency located in the vending machine.

53. The apparatus of claim 47, the data input interface comprising a communication port operable to collect the first set of data via automatic transmission of the first set of data from the vending machine or an audit device associated with the vending machine.

54. The apparatus of claim 53, the communication port further operable to collect the first set of data via transmission of the first set of data via a wireless coupling.

55. The apparatus of claim 53, the communication port further operable to collect the first set of data via transmission of the first set of data via a wire-line coupling.

56. The apparatus of claim 47, the data input interface further operable to collect the first set of data via manual data entry of the first set of data.

57. The apparatus of claim 47, the data input interface further operable to collect the second set of data from an audit device associated with the vending machine.

58. The apparatus of claim 47, the second set of data comprising data exchange (DEX) data associated with the vending machine.

59. The apparatus of claim 47, further comprising a wireless handheld device.

60. The apparatus of claim 47, the data input interface comprising a communication port operable to collect the second set of data via automatic transmission of second set of data from a host device.

61. An apparatus for identifying and correcting data integrity problems associated with remotely located equipment comprising:
at least one memory;
at least one communication port operably coupled to the memory, the communication port operable to receive, from the remotely located equipment, a first set of data associated with the remotely located equipment;
at least one processor operably coupled to the memory and the communication port, the processor operable to:
compare the first set of data with a second set of data; and
based at least on the comparison, identify one or more data integrity problems associated with the remotely located equipment.

62. The apparatus of claim 61, the processor further operable to:
(a) collect the second set of data,
(b) compare the first set of data with the second set of data, and
(c) identify the one or more data integrity problems
substantially contemporaneously with a service technician's dispatch to the remotely located equipment.

63. The apparatus of claim 62, further comprising a user interface operable to provide instructions to a service technician to correct the one or more data integrity problems.

64. The apparatus of claim 61, the first set of data comprising information associated with an expected state of the remotely located equipment.

65. The apparatus of claim 61, the second set of data comprising information associated with an actual state of the remotely located equipment.

66. The apparatus of claim 61, the data input interface comprising a communication port operable to collect the first set of data via automatic transmission of the first set of data from the remotely located equipment.

67. The apparatus of claim 66, the communication port further operable to collect the first set of data via transmission of the first set of data via a wireless coupling.

68. The apparatus of claim 66, the communication port further operable to collect the first set of data via transmission of the first set of data via a wire-line coupling.

69. The apparatus of claim 61, the data input interface further operable to collect the first set of data via manual data entry of the first set of data.

70. The apparatus of claim 61, further comprising a wireless handheld device.

71. The apparatus of claim 61, the data input interface comprising a communication port operable to collect the second set of data via automatic transmission of second set of data from a host device.

72. A computer program for identifying and correcting data integrity problems associated with a vending machine, the computer program embodied in tangible computer readable media and when executed operable to:
collect a first set of data;
collect a second set of data associated with the vending machine;
compare the first set of data with a second set of data; and
based at least on the comparison, identify one or more data integrity problems associated with the vending machine.

73. The computer program of claim 72, further operable to:
(a) collect the second set of data,
(b) compare the first set of data with the second set of data, and
(c) identify the one or more data integrity problems
substantially contemporaneously with a service technician's dispatch to the vending machine or an audit device associated with the vending machine.

74. The computer program of claim 73, further operable to provide instructions to a service technician to correct the one or more data integrity problems.

75. The computer program of claim 72, the first set of data comprising information associated with an expected state of the vending machine.

76. The computer program of claim 72, the second set of data comprising information associated with an actual state of the vending machine.

77. The computer program of claim 72, the data integrity problems comprising at least one of: (a) a data integrity problem associated with a model type of the vending machine, (b) a data integrity problem associated with a planogram of the vending machine, (c) a data integrity problem associated with inventory of the vending machine, and (d) a data integrity problem associated with currency located in the vending machine.

78. The computer program of claim 72, the second set of data collected via automatic transmission of the second set of data from the vending machine or an audit device associated with the vending machine.

79. The computer program of claim 78, the second set of data collected via transmission of the second set of data via a wireless coupling.

80. The computer program of claim 78, the second set of data collected via transmission of the second set of data via a wire-line coupling.

81. The computer program of claim 72, the second set of data collected via manual data entry of the second set of data.

82. The computer program of claim 72, the handheld computing device further operable to collect the second set of data from an audit device associated with the vending machine.

83. The computer program of claim 72, the second set of data comprising data exchange (DEX) data associated with the vending machine.

84. The computer program of claim 72, the collecting of the first set of data comprising transmitting the first set of data from a host device to the handheld computing device.

85. A computer program for identifying and correcting data integrity problems associated with a remotely located equipment, the computer program embodied in tangible computer readable media and when executed operable to:
collect a first set of data;
collect a second set of data associated with the remotely located equipment;
compare the first set of data with a second set of data; and
based at least on the comparison, identify one or more data integrity problems associated with the remotely located equipment.

86. The computer program of claim 85, further operable to:
(a) collect the second set of data,
(b) compare the first set of data with the second set of data, and
(c) identify the one or more data integrity problems
substantially contemporaneously with a service technician's dispatch to the remotely located equipment.

87. The computer program of claim 86, further operable to provide instructions to a service technician to correct the one or more data integrity problems.

88. The computer program of claim 85, the first set of data comprising information associated with an expected state of the remotely located equipment.

89. The computer program of claim 85, the second set of data comprising information associated with an actual state of the remotely located equipment.

90. The computer program of claim 85, the second set of data collected via automatic transmission of the second set of data from the remotely located equipment.

91. The computer program of claim 90, the second set of data collected via transmission of the second set of data via a wireless coupling.

92. The computer program of claim 90, the second set of data collected via transmission of the second set of data via a wire-line coupling.

93. The computer program of claim 85, the second set of data collected via manual data entry of the second set of data.

94. The computer program of claim 85, the collecting of the first set of data comprising transmitting the first set of data from a host device to the handheld computing device.
